(19) United States
(12) Patent Application Publication
(10) Pub. No.: US 2008/0072280 A1
(43) Pub. Date: Mar. 20, 2008

(54) Method and system to control access to a secure asset via an electronic communications network

(76) Inventors: Joseph John Tardo, Palo Alto, CA (US); Amol Mahajani, Saratoga, CA (US); Michael Simonsen, Los Altos, CA (US); Dominic Wilde, Morgan Hill, CA (US); Sanjeev Kumar Dalal, Pune (IN)

Correspondence Address: PATRICK REILLY, P.O. BOX 7218, SANTA CRUZ, CA, 95061-7218, US

(21) Appl. No.: 11/879,224

(22) Filed: Jul. 16, 2007

Related U.S. Application Data
(63) Continuation-in-part of application No. 11/513,332, filed on Aug. 30, 2006.

(51) Int. Cl. G06F 21/00

(52) U.S. Cl. 726/1

(57) ABSTRACT

A method and system for enabling a secure electronic network communications asset is provided. A computational engine networked with an electronic communications is configured to comprise a network endpoint. One, two or a group of particular applications or network services enabled by that endpoint are identified as an addressable secure asset. Policies are established and implemented to limit interactivity between the secure asset and any communications interface to which the asset is connected. The endpoint is configured to be accessible by one or more specific user groups under possibly unique sets policies assigned to each user group. Any network endpoint must be a member of one at least user group in order to access the secure asset and must abide by the policies imposed by the secure asset onto the including user group.

### CO-PENDING APPLICATION

The present invention is a continuation-in-part of U.S. Nonprovisional patent application Ser. No. 11/513,332, entitled “Secure electronic communitarians pathway”, and filed on Aug. 30, 2006. Aforementioned U.S. Nonprovisional patent application Ser. No. 11/513,332 is hereby incorporated in its entirety and for all purposes in this patent application.

### FIELD OF THE INVENTION

The Present Invention relates generally to electronic communications systems and techniques. More particularly, the Present Invention relates to assets, such as information technology systems and services, software programs, data structures, software databases, and computer-controlled equipment, that are accessible via electronic communications networks.

### BACKGROUND OF THE INVENTION

Numerous assets are made accessible to authorized users, consumers, and the general public by means of electronic communications networks, such as telephony systems and the Internet. These assets include, but are not limited to, (1.) information technology systems; (2) information technology applications, (3.) information technology services; (4.) software structures, programs, and databases; and (5.) electronic equipment. It is often advantageous, if not necessary, to securely protect and these accessible assets from damage, misuse and unauthorized access while enabling accessibility these same assets to authorized users under preferred terms and conditions of service and use.

A functionality of a secure asset may be hosted or made available to the network by a first endpoint under the restrictions and permissions of a set of asset polices that are enforced by the first endpoint. A first user group may have access to the first endpoint under the restrictions and permissions of a set of first user group polices, and a second user group may have access to the first endpoint under the restrictions and permissions of a set of second user group polices. In addition, the first endpoint may have a set of first endpoint policies that determine the terms and conditions under which an identified user at a specified secondary endpoint may have access to either the first endpoint or to one or more functionalities of one or more secure assets of, or accessible by means of, the first endpoint. Furthermore, each secondary endpoint may impose a set of policies that impose restrictions and enable permissions selectively to different users and user groups.

In any particular attempt to access a specific functionality of a secure asset via an electronics communications network, the outcome of that attempt will be determined by: (1.) the immediate or relevant input of the user to a selected secondary endpoint; (2.) the policies of all of the user groups to which the user of the previous step 1 belongs; (3.) the policies of the secondary endpoint selected in the preceding step 1 as applied to the user groups identified in the preceding step 2; (4.) the policies of the first endpoint as applied to the particular secondary endpoint selected in step 1; and (5.) the policies imposed by the first endpoint regarding access to the specified functionality of the secure asset which the user of step 1 is attempting to access.

More particularly, a given first endpoint might impose policies differently upon different secondary endpoints. And one or more secondary endpoints might uniquely impose policies in light of the identity of users and user groups that include a particular user.

The myriads of policies that may be imposed when a unique user is a member of multiple user groups and may user several secondary endpoints from time to time, and to access many different functionalities of multiple first endpoints may create a significant computational and administrative burden on a communications network of an enterprise. Inability to manage this complexity can also result in errors or omissions.

The prior art includes systems and methods for managing user group policies in information technology networks. Prior art examples include U.S. Pat. No. 7,127,670 disclosing document management systems and methods; U.S. Pat. No. 7,127,606 disclosing an account-based digital signature (ABDS) system; U.S. Pat. No. 7,124,302 disclosing systems and methods for secure transaction management and electronic rights protection; U.S. Pat. No. 7,124,203 disclosing a method for selective cache flushing in identity and access management systems; U.S. Pat. No. 7,124,192 disclosing a role-permission model for security policy administration and enforcement; U.S. Pat. No. 7,124,110 disclosing a method and apparatus for message flow and transaction queue management; U.S. Pat. No. 7,124,101 disclosing an asset tracking in a network-based supply chain environment U.S. Pat. No. 7,123,608 disclosing a method, system, and computer program product for managing database servers and service; U.S. Pat. No. 7,120,934 disclosing a system, method and apparatus for detecting, identifying and responding to fraudulent requests on a network; U.S. Pat. No. 7,120,800 disclosing systems and methods for secure transaction management and electronic rights protection; U.S. Pat. No. 7,120,596 disclosing a system, method and computer program product for landed cost reporting in a supply chain management framework; and U.S. Pat. No. 7,114,037 disclosing a method and system employing local data stores to maintain data during workflows.

Other prior art examples include U.S. Pat. No. 7,073,172 disclosing on demand patching of applications via a software implementation installer mechanism; U.S. Pat. No. 6,950,818 disclosing a system and method for implementing group policy; U.S. Pat. No. 6,836,794 disclosing a method and system for assigning and publishing applications; U.S. Pat. No. 6,785,728 disclosing distributed administration of access to information; U.S. Pat. No. 6,466,932 disclosing a system and method for implementing group policy; U.S. Pat. No. 6,418,554 disclosing a software implementation installer mechanism; U.S. Pat. No. 6,408,336 disclosing distributed administration of access to information; U.S. Pat. No. 6,389,589 disclosing a class store schema; U.S. Pat. No. 6,345,386 disclosing a method and system for advertising applications; U.S. Pat. No. 6,178,505 disclosing secure delivery of information in a network; and U.S. Pat. No. 6,105,027 disclosing techniques for eliminating redundant access checking by access filters.

Large elements of the public and private spheres of the world economy presently rely upon electronic communications to effectively operate. The rapid proliferation of communications networks that incorporate digital computing technology has greatly increased the efficiency by which large amounts of information are collected and accessed while creating new dangers in the need to maintain information security and operational integrity of these networks and assets available by means of these electronic communications networks. In pursuit of conformance with laws, regulations, security concerns and/or security policies, many enterprises are required to operate internal private networks that often need to exchange sensitive information with external communications points while simultaneously maintaining adequate internal safeguards.

In general, digital electronic communications are formatted as messages by means of a computational device, such as a personal computer, wherein the message specifies a message origination address and a destination address. The message origination address, or source address, may be the address of a device that originated or forwarded either the message or some content of the message. The prior art often applies encryption and authentication techniques to guard against the unauthorized insertion of electronic messages into information technologies systems and networks, and the unauthorized access to, or disclosure of information contained in electronic messages. Yet the prior art places the burden of communications security largely on the originating source computer and the computer designated as the destination of an electronic message. This depends upon either additional host software at both source and destination, or external “gateway” devices capable of locating the corresponding gateway at the intended destination. In a large communications network, the prior art may thereby impose costly and difficult to administrate requirements to update the security software of multiplicities of computers in order to maintain efficient message traffic.

The Internet is currently the single most ubiquitous and economically significant communications network. Under Internet Protocol (hereafter “IP”), a message may consist of one or more network packets where each network packet is separately transmitted, but each network package of a same message refers to a same (a.) message identification, (b.) IP source address, and (c.) IP destination address. Internet is distinguished from other electronic communications networks by the use of a set of protocols called TCP/IP (Transmission Control Protocol/Internet Protocol). Two recent adaptations of Internet technology, the intranet and the extranet, also make use of the TCP/IP protocol.

The Internet Protocol Security standard (hereafter “IPsec”) has been published and periodically updated in an effort to achieve these goals. IPsec may be described as a framework of open standards for ensuring secure private communications over the Internet. Based on standards developed by the Internet Engineering Task Force, IPSec attempts to increase the confidentiality, integrity, and authenticity of data communications across a public network. IPSec is intended to provide necessary components of a standards-based, flexible solution for deploying a network wide security policy.

The prior art also employs Internet Key Exchange (hereafter “IKE”). IKE is a cryptographic key negotiation protocol that allows IPsec users to agree on security services, i.e., authentication and encryption methods, the keys to use, and how long the keys are valid before new keys are automatically exchanged. Prior art IKE methods and applications include attempts to protect against denial of service and man-in-the-middle attacks and ensures non-repudiation, perfect forward secrecy, and key security via periodic refreshing of keys.

Technically, IKE is a dual phase protocol, wherein phase 1 authenticates each peer and creates a secure encrypted link for doing phase 2—the actual negotiation of security services for the IPsec-compliant virtual private network channel. After phase 2 is completed, the protected link in phase 1 is torn down and data traffic abides by security services set forth in the phase 2 negotiations, e.g., encapsulating a security payload with triple data encryption.

There is therefore a long felt need to provide a system and method to automatically merge and generate new sets of policies that are, or comprise, one or more syntheses of previously generated and enabled sets of policies.

The entire disclosures of each and every patent mentioned in this present disclosure, to include U.S. Pat. Nos. 7,127,670; 7,127,606; 7,073,172; 6,950,818; 6,836,794; 6,785,728; 6,466,932; 6,418,554; 6,408,336; 6,389,589; 6,345,386; 6,178,505; 6,105,027; 7,124,302; 7,124,203; 7,124,192; 7,124,110; 7,124,101; 7,123,608; 7,120,934; 7,120,800; 7,120,596; 7,114,037; 7,073,172; 6,950,818; 6,836,794; 6,785,728; 6,466,932; 6,418,554; 6,408,336; 6,389,589; 6,345,386; 6,178,505; and 6,105,027 as noted above, are incorporated herein by reference and for all purposes.

The term “electronic communications security” refers herein to methods and systems intended to create secure computing platforms and communications networks that are designed so that agents, e.g., human users and software programs, can only perform actions that have been allowed. The term “asset security” refers herein to methods and systems intended to (1.) protect the integrity and/or (2.) limit and restrict access, use, modification and management of a secure asset. The term “secure asset” is defined herein to include assets that are accessible, preferably under specific terms and conditions, via an electronic communications network, to include, but limited to, (1.) information technology systems; (2.) information technology services; (3.) software structures, programs, and databases; and (4.) electronic equipment. The term “functionality” is defined herein as an aspect, quality or capability of a secure asset that may be accessed by means of an information technology system and/or an electronic communications network.

### OBJECTS OF THE INVENTION

It is an object of the method of the present invention to support the integrity of communications to or from a secure asset via an electronic communications network.

It is an additional object of the method of the present invention to provide a method to enforce policies regulating access to a functionality of a secure asset accessible via an electronic communications network.

It is an additional object of certain alternate preferred embodiments of the method of the present invention to provide a method for managing the complexity of such policies using techniques that allow composition from manageable elements.

### SUMMARY OF THE INVENTION

These and other objects will be apparent in light of the prior art and this disclosure. In accordance with the method of the present invention, a method and system for enabling access to a secure asset may be provided, wherein a computer network includes one or more secure assets, a first endpoint and a plurality of secondary endpoints.

According to the method of the present invention, a new set of policies of a specified user group may be generated by merging two or more sets of policies that are each separately assigned to different user groups, wherein at least one user is a member of each of the different user groups. The new set of polices may, in certain alternate preferred variations of the method of the present invention, include considerations of the policies applied by individual secondary endpoints to specific users, user groups, other specific secondary endpoints, individual assets and separately identified asset functionalities.

The term endpoint as used herein identifies a computer that is configured to both communicate with an electronic communications network and to establish communications with one or more other computers (hereafter “endpoints”). An endpoint may be a computational engine, such as a personal computer or network computer, designed for use on an electronic communications network and configured to access software programs and digitally coded information provided by servers, and/or other computational engines, to one or more endpoints.

Certain alternate preferred embodiments of the method of the present invention include one or more aspects or affects of (a.) selecting a secure asset functionality of the first endpoint; (b.) assigning a first group of users on secondary endpoints as members of a first user group; (c.) enabling access to a functionality of the first endpoint by the members of the first user group; and/or (d.) denying access to a functionality of the first endpoint by any secondary endpoint whose user may be not identified as a member of the first user group.

In various alternate preferred embodiments of the method of the present invention, (1.) one or more sets of policies applied by the first endpoint may enable and limit access to a functionality by the first user group; (2.) or more sets of policies applied by one or more secondary endpoints may enable and limit access to a functionality of the first endpoint; (3.) a plurality of user groups may be formed, wherein at least one user on a secondary endpoint may be a member of at least two user groups; (4.) a second user group may be defined and a second set of policies may be automatically generated and applied to the second user group; (5.) a plurality of alternate user groups may be formed, and a second set of policies may be applied by the first endpoint to enable and limit access to said functionality by at least one alternate user group; (6.) at least one user on one secondary endpoint of the plurality secondary endpoints may be a member of at least two alternate user groups, and the at least one secondary endpoint may access a functionality as enabled by any alternate user group to which the user on that endpoint is a member; (7.) one or more set of policies applied by the first endpoint to enable and limit access to a functionality by the first user group may include at least encryption policy, whereby secure communications rules may be automatically applied to the interactivity of the members of the first user group with a functionality; (8.) at least one secondary endpoint of the a user group attempting to access a functionality may negotiate IKE keys with another endpoint; (9.) at least one secondary endpoint may access a functionality of a secure asset by means of encrypted electronic communications techniques; (10.) access to a functionality of a secure asset may be limited to encrypted incoming connections; (11.) a set of applications of a server may be identified as a functionality, and an identity and network address of the server may be declared as the functionality to a central controller; (12.) at least one group of servers may be defined and a server may be declared as a member of the at least one group of servers; (13.) at least one client group comprising at least two secondary endpoints may be defined and allowed access to a functionality; (14.) at least one client group may be allowed access to the functionality in accordance with a set of firewall rules, wherein the set of firewall rules allow and/or limit access to the functionality; (15.) at least client included a client group may operate with individual access rights to a functionality, and firewall rules may be merged in with an access right of a client; (16.) a set of firewall policies applied by a server to enable and limit access to a functionality by a client group may include an encryption policy, whereby secure communications rules may be automatically applied to the interactivity of the members of the client user group with the functionality; (17.) a member of a client group attempting to access a functionality may negotiate IKE keys with a server; (18.) a member of a client group may access a functionality by means of encrypted electronic communications techniques, (19.) a set of bandwidth control policies applied to a client user group in order to effectively manage the available network bandwidth and preserver service quality, and/or (20.) a visualization display that permits query of the effective policies governing any particular instance of user access to the secure asset.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is a schematic of a communications network including a plurality of secure network access devices and endpoints;

FIG. 2 is a schematic of an endpoint of FIG. 1;

FIG. 3 is a schematic of a secure network access device of FIG. 1;

FIG. 4 is a format diagram of a network packet that may be transmitted between the endpoints of FIGS. 1 and 2 and by means of the communications network of FIG. 1;

FIG. 5 is a flowchart of a processing of a message in accordance with a first preferred embodiment of the Method of the Present Invention, or first version, as implemented by the communications network, the endpoint and the secure network access device of FIGS. 1, 2 and 3;

FIG. 6 is a flowchart of an alternate, optional or additional processing of a message in accordance with the first version, as implemented by the communications network, the endpoint and the secure network access device of FIGS. 1, 2 and 3;

FIG. 7 is a flowchart of an alternate preferred variation of the first method of FIGS. 5 and 6; and

FIG. 8 is a schematic diagram of a plurality of software encoded policy records;

FIG. 9 is a schematic diagram of a plurality of policy group records that reference the software encoded policy records of FIG. 8;

FIG. 10 is a schematic diagram of a plurality of user group policy assignment records that reference the policy group records of FIG. 9 and the software encoded policy records of FIG. 8;

FIG. 11 is a method in accordance with still additional alternate preferred embodiments of the method of the present invention of merging references to policy group records of FIG. 9 in the user group policy assignment records of FIG. 10, and newly generating policy group records and updating user group policy assignment records of FIG. 10;

FIG. 12 is a schematic diagram of a plurality of user group policy assignment records of FIG. 10 that have been updated in accordance with an illustrative example of the application of the method of FIG. 11;

FIG. 13 is a process chart of a second alternate preferred embodiment of the method of the present invention, wherein a method of providing a secure asset of FIG. 1 by means of the computer network of FIG. 1 is provided;

FIG. 14 is a flowchart in accordance with certain yet other alternate preferred embodiments of the method of the present invention wherein a plurality of policy groups records of FIG. 9. are formed and user group policy assignment records of FIG. 10 are modified;

FIG. 15 is a flowchart in accordance with certain still other alternate preferred embodiments of the method of the present invention wherein a plurality of alternate policy group records of FIG. 9 are formed and a user may use at least one secondary endpoint of FIG. 1 to access the functionality of a first endpoint of FIG. 1 as enabled by any alternate user group of FIG. 9; and

FIG. 16 is a flowchart in accordance with certain yet other alternate preferred embodiments of the method of the present invention, wherein a singular or a set of secures assets of FIG. 1 are each one or more functionalities software applications of a server of FIG. 1 may be identified as individually addressable secure assets.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

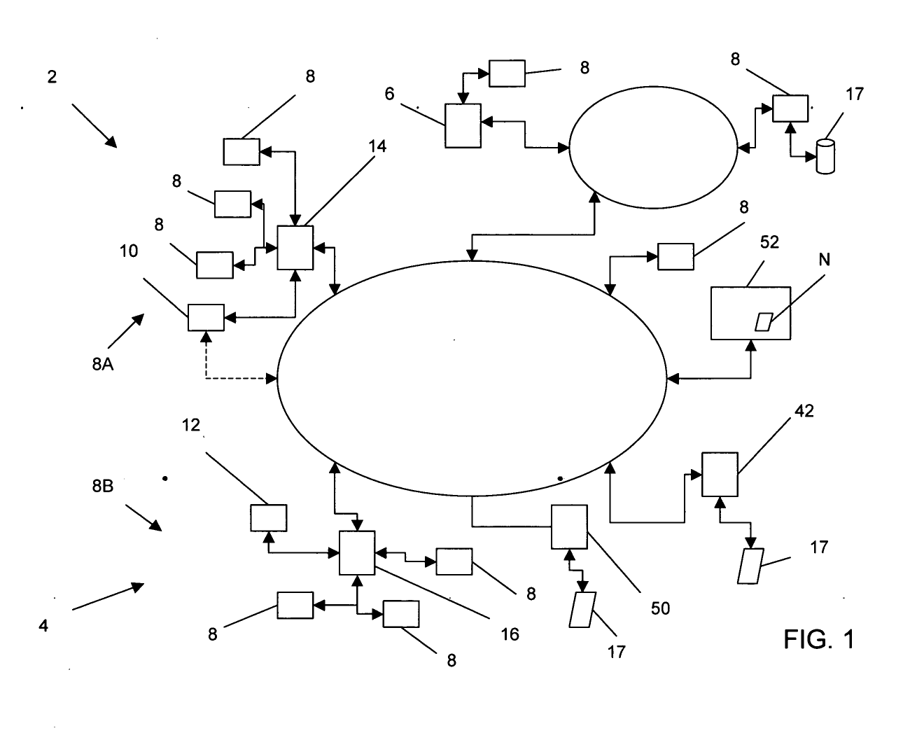

Referring now generally to the Figures and particularly to FIG. 1, FIG. 1 is a schematic of an electronics communications network 2 that includes the Internet 4, a plurality of network computers 6 and a plurality of endpoints 8. Each endpoint 8, to include a first endpoint 10 and a second endpoint 12, is configured to send and to receive electronic messages via at least one secure network access device 6, 14 & 16. Each network access device 6, to include a first secure network access device 14 and a second secure network access device 16, is configured to send and receive electronic messages via the communications network 2. Each secure network access device 6, 14 & 16 may optionally be configured to receive electronic messages from at least one endpoint 8, 10 & 12 and to forward on the electronic messages received from the at least one endpoint 8, 10 & 12 to the Internet 4. Each secure network access device 6, 14 & 16 may additionally, optionally or alternatively be configured to receive electronic messages from the Internet 4 and/or the communications network 2 and to forward on the electronic messages received from the Internet 4 and/or communications network 2 to at least one endpoint 8, 10 & 12.

One or more secure assets 17 may reside within, or be communicatively coupled with, a one or more endpoint 8, 10, & 12, or be distributed between or among two or more endpoints 8, 10 & 12 of the network 2. The secure asset may be or comprise an information technology system; (2.) an information technology service; (3.) a software structure, program, or databases; and/or (4.) an electronic equipment.

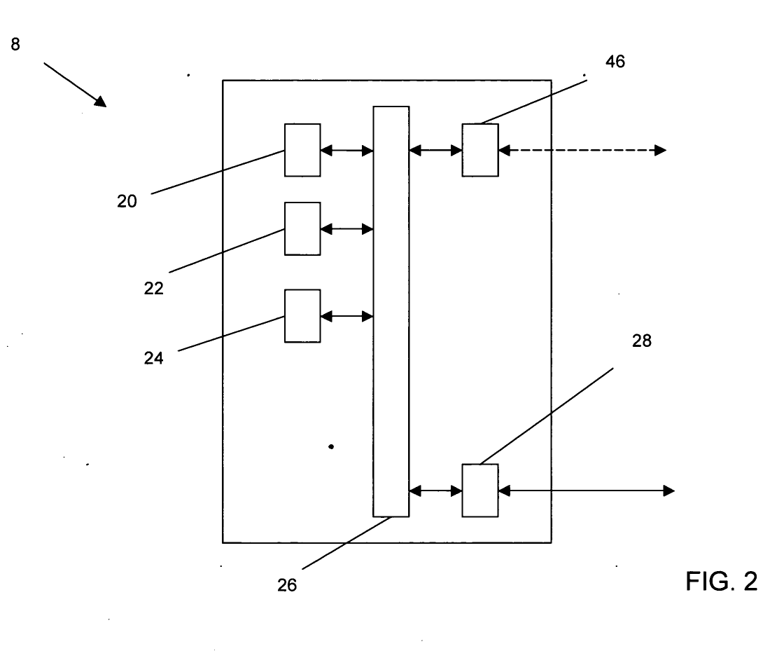

Referring now generally to the Figures and particularly to FIG. 2, FIG. 2 is a schematic of an endpoint 8, 10 & 12. The endpoint 8, 10 & 12 is a digital computer that includes a processor 18, a memory 20, an input device 22, a monitor 24, an internal endpoint communications bus 26 and a message interface 28. An endpoint 8, 10 or 12 may be comprised within a server or an intelligent peripheral device, such as a printer having a processor 18, a memory 20, and a message interface 28. The internal endpoint communications bus 26 bi-communicatively couples, and provides bi-directional communication to, the processor 18, the memory 20, the input device 22, the monitor 24, and the message interface 28. The input device 22 may be or comprise an electronic keyboard or other suitable input device known in the art that enables a human user to provide content to the endpoint 8, 10 or 12 for an electronic message. The memory 20 stores endpoint software that directs the processor 18 to generate, transmit and receive electronic messages. The monitor 24 may be or include a video monitor or other suitable output device that enables the human user to view at least some of the content of an electronic message. The message interface 28 bi-directionally communicatively couples the internal communications bus 26 with at least one secure network access device 6, 14 or 16, whereby the endpoint 8, 10 & 12 may send and/or receive electronic messages to and/or from the Internet 4 and/or the communications network 2.

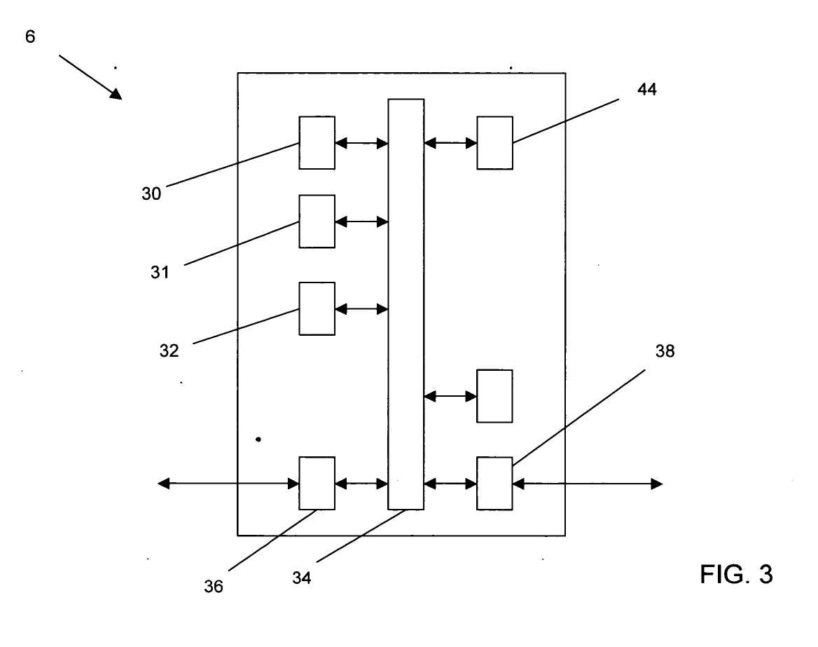

Referring now generally to the Figures and particularly to FIG. 3, FIG. 3 is a schematic of a secure network access device 6, 14 & 16. The secure network access device 6, 14 & 16 includes a data plane network processor 30, a control plane processor 31, a network memory 32, a network internal communications bus 34, an endpoint interface 36, and a network interface 38. The network internal communications bus 34 bi-communicatively couples, and provides bi-directional communication to, the data plane network processor 30, the network memory 32, the endpoint interface 36, and the network interface 38. The network memory 32 stores the network access device system software that directs the data plane network processor 30 to generate, transmit and receive electronic messages to and/or from the Internet 4, the communications 2, and/or at least one endpoint 8, 10 or 12. The network interface 38 bi-directionally communicatively couples the network internal communications bus 34 with the Internet 4 and/or the communications network 2. The endpoint interface 36 bi-directionally communicatively couples the network computer 6, 14 or 16 with at least one endpoint 8, or 12, whereby the endpoint 8, 10 & 12 may send and/or receive electronic messages to and/or from the Internet 4 and/or the communications network 2, by means of the secure network access device 6, 14 & 16.

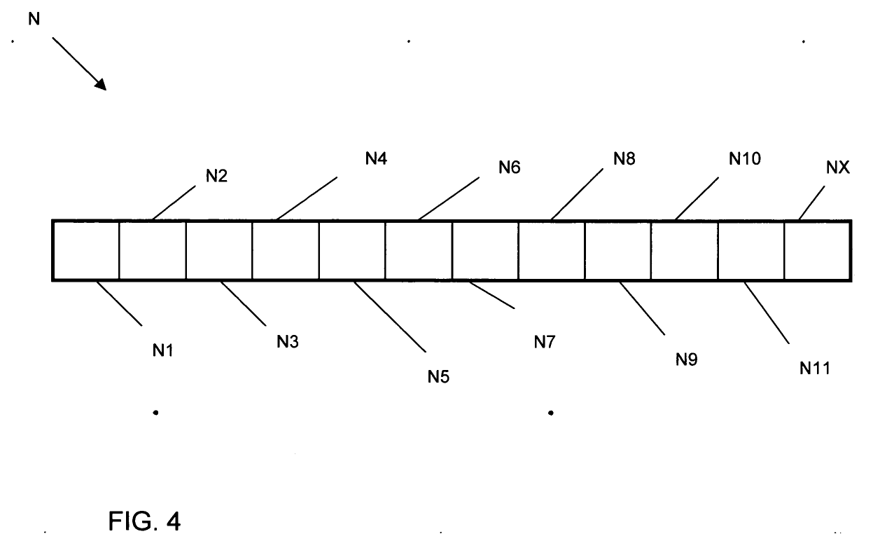

Referring now generally to the Figures and particularly to FIG. 4, FIG. 4 is a format diagram of a network packet N, the network packet N including packet data fields N1-NX, and the network packet formatted in accordance with the IPsec standard or another suitable electronic communications and data security message formatting known in the art. The header data field N1 contains information related to the network packet N, to include the source address S.ADDR and the destination address D.ADDR. A message payload is stored in a payload data field N2, and other information is stored in the remaining packet data fields N3-NX. The network packet N may be transmitted between the endpoints 8, 10, 12 and by means of the communications network 2.

It is understood that encrypting and decrypting of network packets in accordance with the first method may comply with the IPsec encryption standard (RFC2401), and the encrypted messages may comprise the MAC and IP addresses of the communicating endpoints.

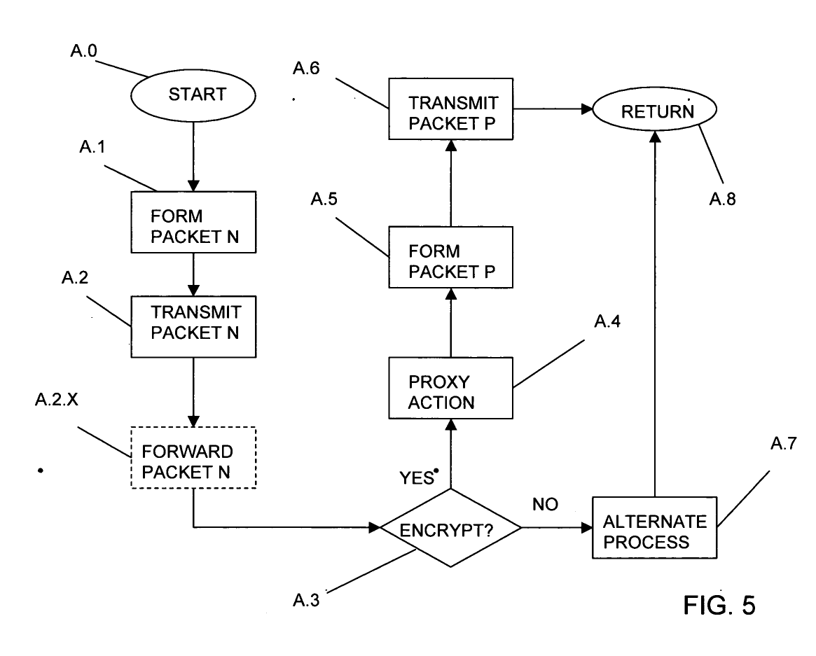

Referring now generally to the Figures and particularly to FIG. 5, FIG. 5 is a flowchart of a processing of a message in accordance with a first preferred embodiment of the Method of the Present Invention, or first version, as implemented by the communications network 2, the endpoints 8, 10, 12 and the secure network access devices 6, 14, 16 of FIGS. 1, 2 and 3. In step A.1 the first endpoint 10 formats and generates a network packet N, wherein the source address value S.ADDR identifies the first endpoint 10 as the message source and the destination address D.ADDR identifies the second endpoint 12 as the intended message recipient. In step A.2 network packet N is transmitted by the first endpoint 10 to the first secure network access device 14. In step A.3 the first secure network access device 14 examines the network packet N to determine whether the network packet N shall be encrypted. In executing step A.3, the first secure network access device 14 may apply stateful rules to determine whether the network packet N shall be encrypted. When the first secure network access device 14 determines in step A.3 that the network packet N shall be encrypted prior to transmission via the network 2, the first secure network access device 14 engages with the communications network 2 in step A.4 as a proxy for the first endpoint 10 and performs IKE and authentication operations in concert with either the second endpoint 12 or the second secure network access device 16 via the communication network 2. In step A.5 the first secure network access device 14 processes the network packet N with encryption and/or authentication algorithms to generate a processed network packet P. The processed network packet P may be organized and formatted to appear just as the network packet N would have appeared had the first endpoint 10 performed the steps A.4 and A.5. The first secure network access device 14 then transmits the processed network packet P via the communications network 2 along the same pathway that the network packet N would have traveled had the network packet N not been processed by the first secure network access device 14. It is understood that encrypting of step A.5 of network packets N in accordance with the first method may comply with the IPsec encryption standard (RFC2401), and the encrypted network packet P may comprise the MAC and IP addresses of the communicating endpoints 8, 10 OR 12.

In optional step A.2.X an intermediate network device 40 that is transposed between the first endpoint 10 and the first secure network access device 14 receives the network packet N from the first endpoint 10 and forwards on the network packet N to the first secure network access device 14 without changes the format or content of the network packet N. As per FIGS. 1 and 3, the intermediate network device 40 is a network access device 6 configured according to the network access device schematic of FIG. 3, and wherein the network interface 38 of the intermediate computer 40 bi-directionally communicatively couples the network internal communications bus 34 of the intermediate network access device 40 with the first secure network access device 14.

It is understood that a first plurality 8A of endpoint computers 8 may be communicatively coupled with first secure network access device 14, wherein the first secure network access device 14 may act as a proxy for each of the coupled endpoint computer 8 and process network packets N received from each coupled endpoint computer 8 of the first plurality 8A in accordance with the network system software of the first secure network access device 14. It is further understood that a second plurality 8B of endpoint computers 8 may be communicatively coupled with second secure network access device 16, wherein the second secure network access device 16 may act as a proxy for each of the coupled endpoint computers 8 of the second plurality 8A and process network packets N received from each coupled endpoint computer 8 in accordance with the network system software of the second secure network access device 16.

In certain preferred alternate embodiments of the Method of the Present Invention, the first secure network access device 14 may elect to process network packets N received from the first endpoint 10 and/or an endpoint 8 of the first plurality of endpoints 8 in concert with or in accordance with instructions received from a controller network computer 42 of the communications network 2. The controller network computer 42 is a network computer 6 configured according to the network computer schematic of FIG. 3, and wherein the network interface 38 of the controller network computer 42 bi-directionally communicatively couples the network internal communications bus 34 of the controller network computer 42 with the first secure network access device 14 via the communications network 2.

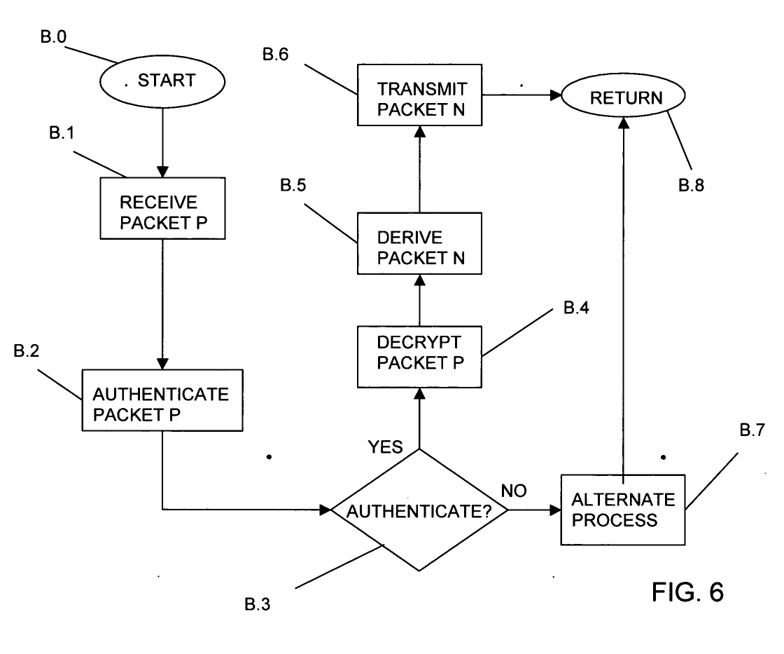

Referring now generally to the Figures and particularly to FIG. 6, FIG. 6 is a flowchart of an alternate, optional or additional processing of a message in accordance with a first preferred embodiment of the Method of the Present Invention, or first version, as implemented by the communications network, the endpoint and the secure network access device of FIGS. 1, 2 and 3. In step B.1 the second endpoint computer 16 receives the processed network packet P via the communications network 2. In step B.2 the second secure network access device 16 authenticates the processed network packet P. After confirming authentication is step B.3, the second secure network access device 16 decrypts the processed network packet P and derives the network packet N from the processed network packet P in step B.4. It is understood that the decrypting of step B.4 of network packets N in accordance with the first method may comply with the IPsec encryption standard (RFC2401), and the encrypted network packet P may comprise the MAC and IP addresses of the communicating endpoints 8, 10 OR 12. The second secure network access device 16 derives the network packet N in step B.5 from the results of the authentication step B.2 and the decryption step B.4. In step B.6 the network packet N is transmitted from the second secure network access device 16 to the second endpoint 8, whereby the second endpoint 8 receives the network packet N and the processing performed by the first secure network access device 14 and the second secure network access device 16 on the network packet N and the processed network packet P is transparent to and undetected by the second endpoint computer.

Referring now generally to the Figures, and particularly to FIGS. 3, 5 and 6, it is understood that the encryption of the network packet N performed in step A.5 of FIG. 5 may be at least partially accomplished by encryption acceleration hardware 44 of the first secure network access device 12. It is further understood that the decryption of the processed network packet P performed in step B.4 of FIG. 6 may be at least partially accomplished by encryption acceleration hardware 44 of the second secure network access device 16.

In certain other alternate preferred embodiments of the Method of the Present Invention, the first endpoint 10 and/or the second endpoint 12 may send and receive network packets N with the intermediation of only one secure network access device 6, 14 or 16. In certain alternate preferred exemplary alternate configurations of the first endpoint 10, the first endpoint 10 may further comprise an endpoint-network interface 46, as per FIG. 2, wherein the endpoint-network interface 46 communicatively couples the endpoint internal communications bus 26 of the first endpoint 10 directly with the communications network 2 and/or the Internet 4. Additionally, optionally or alternatively, certain still alternate preferred exemplary alternate configurations of the second endpoint 12, the second endpoint 12 may further comprise an endpoint-network interface 46, as per FIG. 2, wherein the endpoint-network interface 46 communicatively couples the endpoint internal communications bus 26 of the second endpoint 12 directly with the communications network 2 and/or the Internet 4.

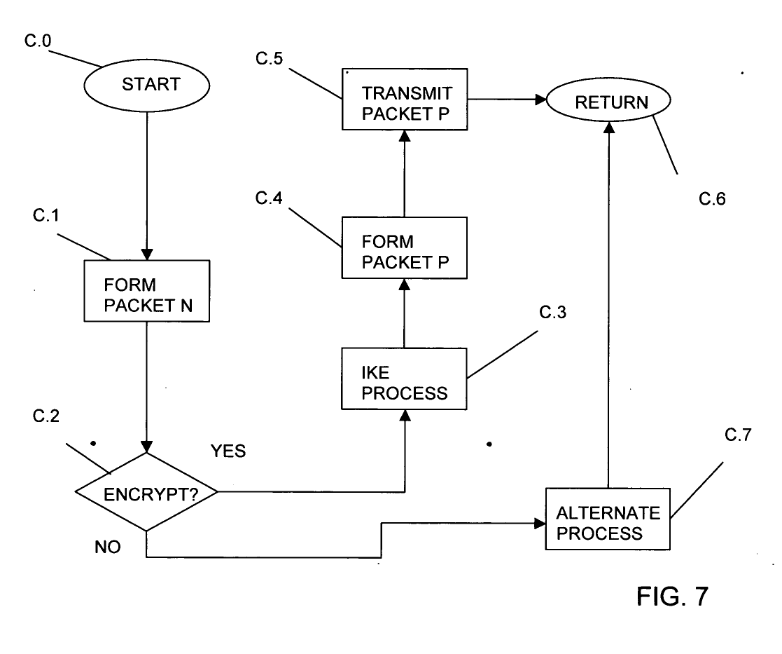

Referring now generally to the Figures and particularly to FIG. 7, FIG. 7 is a flowchart of an alternate preferred variation of the first method, wherein the first endpoint 10 uses the end-point network interface 46 to communicate with the second secure network access device 16 and to optionally authenticate and encrypt the network packet N prior to transmission from the first endpoint 10. In step C.1 the first endpoint 10 formats and generates a network packet N, wherein the source address value S.ADDR identifies the first endpoint 10 as the message source and the destination address D.ADDR identifies the second endpoint 12 as the intended message recipient. In step C.2 the first endpoint 10 examines the network packet N to determine whether the network packet N shall be encrypted. In executing step C.2, the first endpoint 10 may apply stateful rules of the endpoint software of the first endpoint 10 to determine whether the network packet N shall be encrypted. When the first endpoint 10 determines in step C.2 that the network packet N shall be encrypted prior to transmission via the network 2, the first endpoint 10 engages in step C.3 with the second secure network access device 16 via the communication network 2 to perform authentication and IKE data generation. In step C.4 the first endpoint 10 processes the network packet N with encryption and/or authentication techniques, and in accordance with the algorithms and data generated in step C.3, to generate a processed network packet P. The first endpoint 10 then transmits the processed network packet P via the communications network 2 in step C.5. After receipt of the processed network packet P, the second secure network access device 16 then authenticates and decrypts the processed network packet P in accordance with the flowchart of FIG. 6, wherein the second secure network access device 116 derives the network packet N from the processed network packet P, and provides the regenerated network packet N to the second endpoint 12.

It is understood that the second endpoint 12 additionally, optionally, alternatively may further comprise an endpoint network interface 46. Referring now generally to the Figures while continuing to refer particularly to FIG. 7, FIG. 7 the endpoint software of the second endpoint 12 may direct the second endpoint 12 to flowchart to execute an alternate preferred variation of the first method, wherein the second endpoint 12 uses the end-point network interface 46 to communicate with the first secure network access device 14 and to optionally authenticate and encrypt the network packet N prior to transmission from the second endpoint 12. In step C.1 the second endpoint 12 formats and generates a network packet N, wherein the source address value S.ADDR identifies the second endpoint 12 as the message source and the destination address D.ADDR identifies the first endpoint 10 as the intended message recipient. In step C.2 the second endpoint 12 examines the network packet N to determine whether the network packet N shall be encrypted. In executing step C.2, the second endpoint 12 may apply stateful rules of the endpoint software of the second endpoint 12 to determine whether the network packet N shall be encrypted. When the second endpoint 12 determines in step C.2 that the network packet N shall be encrypted prior to transmission via the network 2, the second endpoint 12 engages in step C.3 with the first secure network access device 14 via the communication network 2 to perform authentication and IKE data generation. In step C.4 the second endpoint 12 processes the network packet N with encryption and/or authentication techniques, and in accordance with the algorithms and data generated in step C.3, to generate a processed network packet P. The second endpoint 12 then transmits the processed network packet P via the communications network 2. After receipt of the processed network packet P, the first secure network access device 14 then authenticates and decrypts the processed network packet P in accordance with the flowchart of FIG. 6, wherein the first secure network access device 14 derives the network packet N from the processed network packet P, and provides the regenerated network packet N to the first endpoint 10.

In certain still additional alternate preferred embodiments of the Method of the Present Invention, the controller network computer 42, and optionally in combination with at least one secure network access device 6, 14 or 16 and at least two endpoints 8, 10 and 12, determines whether a particular network packet N shall be encrypted by applying stateful traffic rules. The stateful traffic rules may evaluate one or more of the qualities or aspects of the network packet N, to include the source IP address, the destination IP address and/or communications protocol of the network packet N. If the communications protocol of the network packet conforms to a TCP or a UDP standard, the source port and the destination port may also be partially or wholly determinative of the determination of whether the network packet may be encrypted. If the communications protocol of the network packet conforms to an Internet Control Message Protocol standard, the source and destination types and codes may also be partially or wholly determinative of the determination of whether the network packet may be encrypted.

The rules may include other qualifications, such as group memberships required by clients or user attempting to access an endpoint 8, 10 or 12 or a secure network access device 6, 14 or 16. In certain alternate preferred embodiments of the second method, the controller secure network access device 42 maintains a trusted domain, wherein the trusted domain is limited to specified endpoints 8, 10 & 12 and secure network access device 6, 14 & 16 that are authorized to mutually authenticate as IKE negotiators with other members 6, 8, 10, 12, 14 & 16 of the trusted domain.

When a secure network access device 6, 14 & 16 is acting as a proxy for an endpoint 8, 10 or 12, incoming IKE messages addressed to the instant endpoint 8, 10 or 12 and received by the secure network access device 6, 14 & 16 are examined to determine whether the destination IP address and the source destination IP address both indicate endpoints 8, 10 & 12 are listed as members of the trusted domain by the controller network computer 44. Where both the destination IP address and the source destination IP address are both members of the trusted domain, the secure network access device 6, 14 or 16 acts as a proxy for the endpoint 8, 10 or 12 coupled with the secure network access device 6, 14 or 16. When acting as a proxy, the secure network access device 6, 14 or 16 executes the first method as described herein.

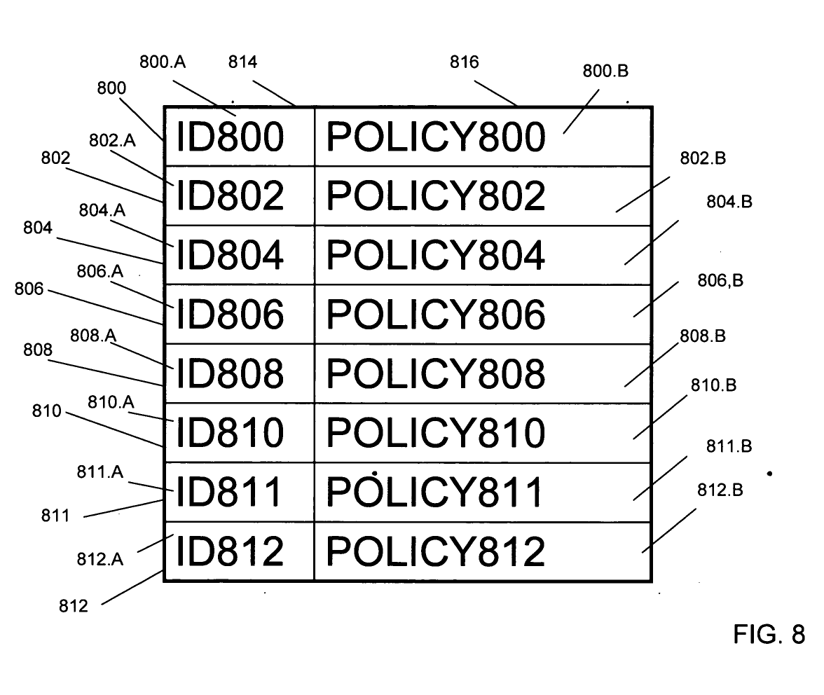

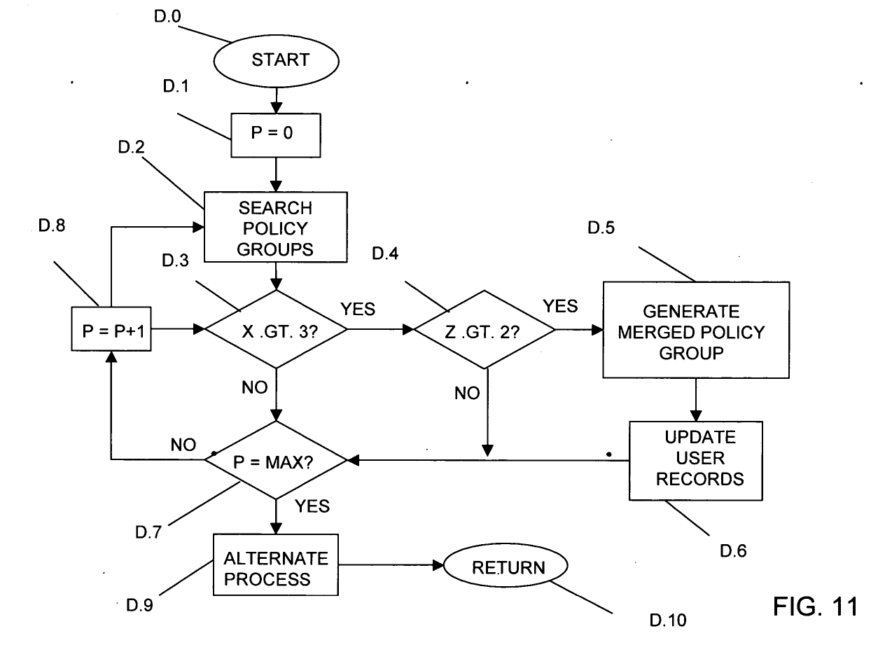

Referring now generally to the Figures and particularly to FIG. 8, FIG. 8 illustrates a plurality of software encoded policy records 800-812. Each policy record 800-812 is a software structure that includes a policy identifier data field 814 and a policy data field 816. Each policy identifier data field 814 includes a unique identifier 800.A-812.A that identifies an individual, machine-readable software encoded policy 800.B-812.B as stored in an associated policy data field 816 of a same policy record 800-812. Examples of the individual effect of a software encoded policy 800.B-812.B (hereafter “policy” 800.B-812.B) might include (1.) a first policy 800.B of a first policy record 800, wherein, the software encoded instructions of the first policy 800.B authorizes a user to read data records 46 of a data base 48 (as per FIG. 11); (2.) a second policy 802.B of a second policy record 802, wherein the software encoded instructions of the second policy 802.B authorizes a user to print data records 46 of the data base 48; and (3.) a third policy 804.B of a third policy record 804, wherein the software encoded instructions of the third policy 804.B authorizes a user to modify data records 46 of a data base 48.

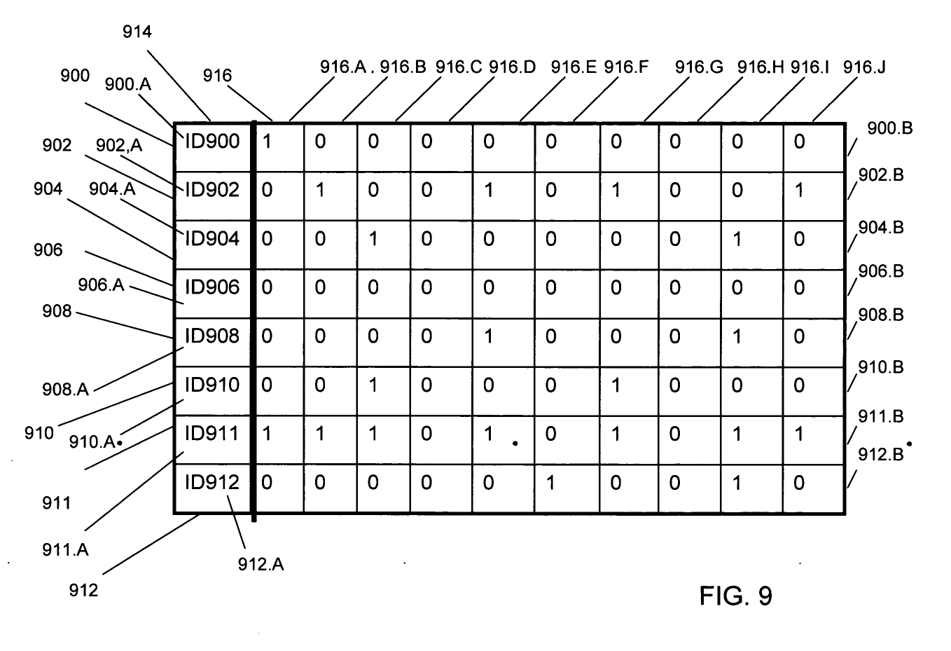

Referring now generally to the Figures and particularly to FIG. 9, FIG. 9 illustrates a plurality of user group policy records 900-912. Each user group policy record 900-912 is a software structure that includes a user group identifier data field 914 and a policy enabler data field 916. Each user group data field 914 includes a unique policy group identifier 900.A-912.A that identifies an associated individual user group policy set 900.B-912B of a same user group policy record 900-912 in a one-to-one correspondence. Each digit position 916.A-916.J of each policy enabler data field 916 includes a flag that indicates whether a software encoded policy 800.B-812.B of a policy record 800-812 is applied or enforced by a particular user group policy set 900.B-912.B For example, a ONE value in the first digit position 916.A indicates that the first policy 800.B will be enforced or applied by an instant user group policy set 900.B-912.B, whereas a ZERO value in the first digit position 916.A indicates that the first policy 800.B will neither be enforced nor applied by an instant user group policy set 900.B-912.B. As another example, a ONE value in the second digit position 916.B indicates that the second policy 802.B will be enforced or applied by an instant user group policy set 900.B-912.B, whereas a ZERO value in the second digit position 916.B indicates that the second policy 802.B will neither be enforced nor applied by an instant user group policy set. As yet another example, a ONE value in the third digit position 916.C indicates that the third policy 804.B will be enforced or applied by an instant user group policy set, whereas a ZERO value in the third digit position 916.C indicates that the third policy 804.B will neither be enforced nor applied by an instant user group policy set.

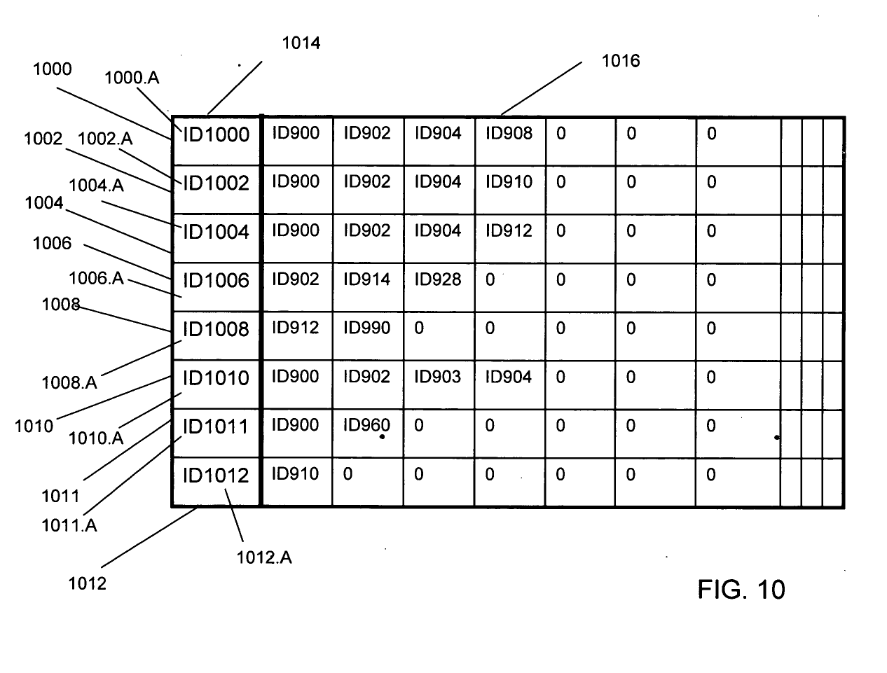

As discussed below in particular reference to FIG. 10, and regarding user group policy assignment records 1000-1012, (hereafter “user records” 1000-1012) each user may be authorized to interact with the network 2 on the basis of assignment to one or more user groups. Each user group assignment record includes a user identifier data field 1014 and a user group policy data field 1016. The assignments of users to user groups may be documented or instantiated by creating a user record 1000-1012 that (1.) stores and associates a user identifier 1000.A stored in a user identifier data field 1014, with (2.) one or more user group policy set identifiers 900.A-912.A stored in the user group policy data field 1016 of a same user record 1000-1012 in a user record policy group data field 1016 of a user records 1000-1012.

Referring now generally to the Figures, and back again to FIG. 9, and examining the first user group policy record 900, the ONE-ZERO-ZERO flag pattern of the first three digit positions 916.A, 916.B & 916.C of the first user group policy set 900 indicates that the first policy 800.B will be applied and enforced, whereas neither the second policy 8002.B nor the third policy 804.B will be applied or enforced by the network 2 to a user identified as being a member of a first user group associated with the first user group policy record 900.

Examining the second user group policy record 902, the ZERO-ONE-ZERO flag pattern of the first three digit positions 916.A, 916.B & 916.C of the first user group policy set 902.B indicates that the second policy 802.B will be applied and enforced, whereas neither the first policy 800.B nor the third policy 804.B will be applied or enforced by the network 2 to a user identified as being a member of a second user group associated with the second user group policy record 902.

Examining now the third user group policy record 904, the ZERO-ZERO-ONE flag pattern of the first three digit positions 916.A, 916.B & 916.C of the third user group policy set 904.B indicates that the third policy 804.B will be applied and enforced, whereas neither the first policy 800.B nor the second policy 802.B will be applied or enforced by the network 2 to a user identified as being a member of a third user group associated with the third user group policy record 904.

Referring now generally to the Figures, and back again to FIG. 10, a user recognized by the network 2 as identified by an instant user identifier 1000.A-1012.A will be permitted by the network 2 to interact with the network 2 in accordance with the machine-readable software encoded policies 800.B-812.B that are directed to be enforced or applied by the policy group set 900.B-912.B that are associated with a policy group identifier 900.A-912.A stored in the user group policy data field 1000.B-1012.B of the same user records 1000-1012 storing the instant user identifier 1000.A-1012.A.

For example, a first user record 1000 indicates that a user recognized by the network 2 as being identified by a user identifier 1000.A may interact with the network 2 in accordance with the software encode policies 800.B-812.B enforced and enabled as directed in accordance with the first, second, third, and fifth software encoded policy sets 900.B, 902.B, 904.B and 908.B of the first, second, third and fifth group policy records 900, 902, 904 and 908.

In two other examples, (1.) a second user record 1002 indicates that a user recognized by the network 2 as being identified by a user identifier 1002.A may interact with the network 2 in accordance with the software encode policies 800-812 enforced and enabled as directed in accordance with the first second, third and sixth software encoded policy sets 900.B, 902.B, 904.B & 910.B of the first, second, third and sixth group policy records 900, 902, 904 and 910; and (2.) a third user record 1004 indicates that a user recognized by the network 2 as being identified by a user identifier 1004.A may interact with the network 2 in accordance with the first, second, third, and sixth software encoded policy sets 900.B, 902.B, 904.B and 912.B enforced and enabled as directed by the first, second, third and seventh group policy records 900, 902, 904 and 912.

Referring now generally to the Figures and particularly to FIGS. 8, 9 and 10, it may be noted that the first, second and third user records 1000, 1002 & 1004 each direct the network 2 to permit any user identified by the network 2 as enabled for interaction by one of these three user records 1000, 1002 & 1004 to interact with the network 2 in accordance with the software encoded policies 800.B-812.B as indicated by the first user group policy record 900, the second user group policy record 902, and the third user group policy record 904. It is understood that each user record 1000-1012 may include additional indications of policies 800.B-812.B to be applied or enforced by the network 2 in the interaction of a user with the network 2.

Referring now generally to the Figures and particularly to FIGS. 8, 9, 10 and 1, FIG. 1 illustrates a controller computer 50 of the network 2 which is an endpoint and stores the policy records 800-812, group policy records 900-912 and the user records 1000-1012 in a memory 20 of the controller computer 50. The controller computer 50 includes the elements 18-28 and aspects of the first endpoint 10 and/or one or more of the elements 30-38 and aspects secure network access 6.

Referring now generally to the Figures and particularly to FIG. 11, FIG. 11 is a flow chart of the controller computer 50, wherein the controller computer 50 generates a new user group policy record 914. In step D.1 a counter P is initialized as zero, wherein the user policy records 900-914 are sequentially ordered with user identifiers each being a unique value inclusively selected from a ZERO value to a MAX value. In step D.2 the user records 1000-1012 are searched to determine the incidence X of a policy group P among the user records 1000-1012. In step D.3 the controller computer 50 determines whether more than three or more user records 1000-1012 signify that a policy record P is applied to an associated user. In step D.4 the controller computer determines an incidence Z of user records 1000-1014 found in step D.2 that both (1.) direct the application of the policy record P; and also (2.) commonly share another policy record 900-912 association in each internal user group policy data field 1016. Where more than three user records 1000-1014 each share more than two policy records 900-914, i.e. Z is greater than two, the controller computer 50 generates a new policy record N in step D.4, wherein the new policy record N directs the network 2 to apply all of the policies 800.B-812.B associated with the policy records 900-914 of step D.2 and step D.3 to any user associated with the new policy record N. Referring now to FIG. 1, the new policy record N may be stored in the memory 20 of the controller computer 50, at an endpoint 8, and/or at a server 52. The server 52 includes the elements 18-28 and aspects of the first endpoint 10 and/or one or more of the elements 30-38 and aspects secure network access 6.

In step D.6 the controller computer 50 updates the user records 1000-1012 selected in step D.4 and stores an association with the new policy record N in each respective user group policy data field 1016 of the user records 1000-1012 selected in step D.4. In step D.7 the counter P is checked to see if the last policy group MAX has been evaluated, and in step D.8 the P value is incremented and the controller computer 50 evaluates the user group records 1000-1014 as described above in reference to steps D.1-D6. When the P value is found to equal MAX in step D.7, the controller computer 50 resets the P counter to zero in step D.9, and the controller computer 50 returns to alternate operation in step D.10.

It is understood that a user record 1000-1012 may identify a secure asset 17, an endpoint 8. 10, & 12, the controller computer 50, and/or a server 52 as a user, wherein the policies 800.B-812.B associated with the designated secure asset 17, an endpoint 8. 10, & 12, the controller computer 50, and/or a server 52 by means of one of the user records 1000-1012 are applied by the network 2, one or more endpoints 8, one or more servers 52, and/or one or more other secure assets 17 to constrain and enable interactions of the instant secure asset 17, an endpoint 8. 10, & 12, the controller computer 50, and/or a server 52 with the network 2. For example, ID1010 of FIG. 10 may be associated with a secure asset 17, wherein the policies of policy group 910 is applied by the network 2 to constrain and enable interactions of the instant secure asset 17 associated with the ID1010 with the network 2.

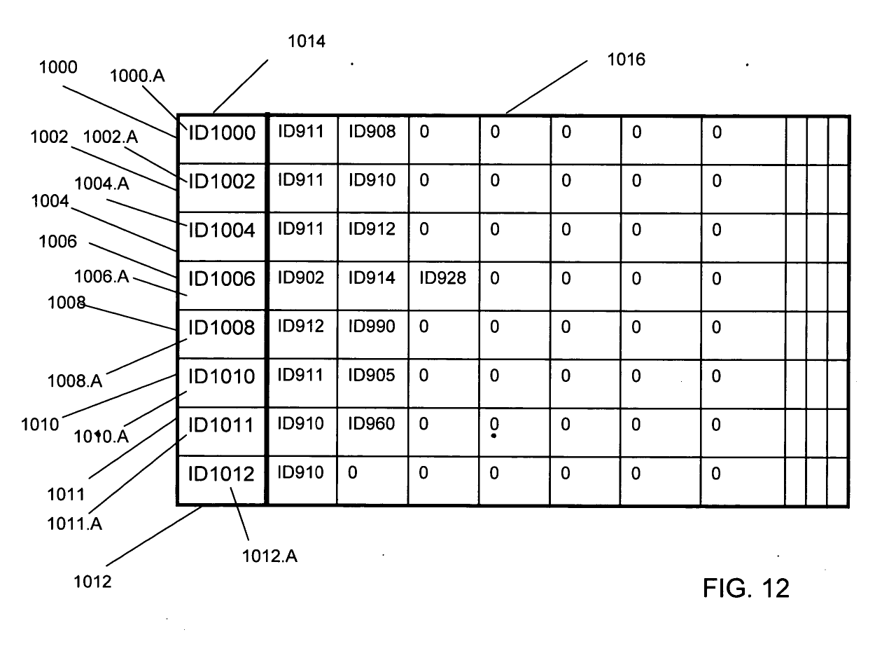

As an illustrative example, consider an execution of the method of FIG. 11, wherein the P value directs the controller computer 50 to examine the incidence X of the first policy group record 900 identified by the ID900 within the user records 1000-1012, wherein the controller computer 50 determines in step D.3 that five user records 1000, 1002, 1004, 1010 & 1011 reference the ID900 in their respective policy group data fields 1016. Where X is greater than three, and in this example equals five. The controller computer 50 proceeds from step D.3 to step D.4 to determine if any other policy group records 900-912 are commonly shared by three or more user records 1000, 1002, 1004, 1010, & 1011 that were selected in step D.2, and determines that four user records 1000, 1002, 1004, & 1010 refer to three policy group policy records 900, 902 & 904 in their respective group policy data field 1016. In step D.5 the controller computer generates a merged policy group 911 that includes all of the policies 800-812 applied by the three user group policy records 900, 902 & 904 in its respective policy data field 916. and in step D.6 the controller computer updates four user records 1000, 1002, 1004, & 1010 selected in step D.5 to delete references to the commonly referenced three user group policy records 900, 902 & 904 and to insert a reference to the newly generated user group policy record 911. Referring now generally to the Figures and particularly to FIG. 12, FIG. 12 is a schematic of the user records 1000-1012 of FIG. 10 as updated in step D.6 of this illustrative example.

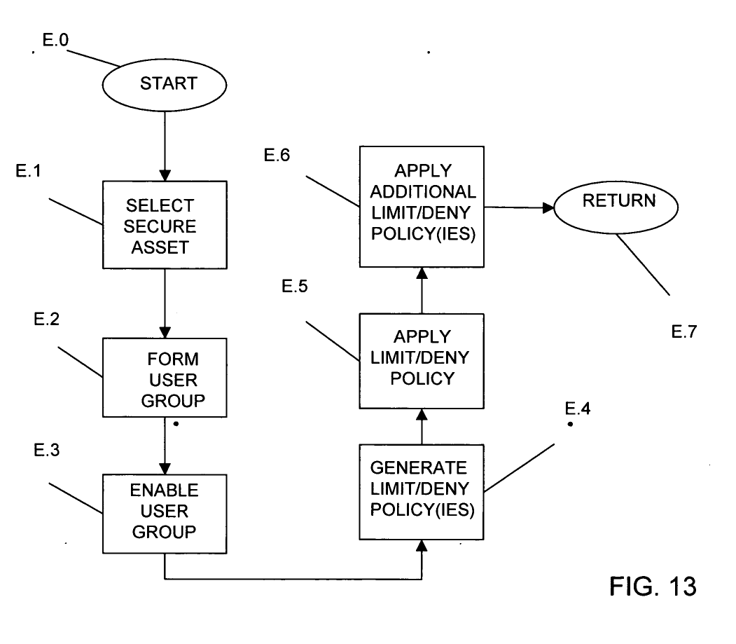

Referring now generally to the Figures and particularly to FIG. 13, FIG. 13 is a process chart of a second alternate preferred embodiment of the method of the present invention, wherein a method of providing a secure asset 17 by means of the computer network 2 is provided. In step E.1 a functionality of a secure asset 17 of the first endpoint 10 is selected. In step E.2 a first group of users of secondary endpoints 12 are each assigned as members of a first user group. A user group may be formed by including a same policy group record identifier 900.A-912.A in each user group policy data field 1016.x of the respective user records 1000-1012 of the user group. In step E.3 the members of the first user group are enabled to access to the functionality of the first endpoint 10 identified in step E.1. In step E.4 access to the secondary endpoints 12 are programmed to deny access to the functionality of the first endpoint 10 by any secondary endpoint 12 whose user is not identified as a member of the first user group. In optional step E.5 a set of software encoded policies 800.B-812 are applied by the first endpoint 10 to enable and limit access to the functionality by the first user group. In optional step E.6 another set of policies 800.B-812.B are applied by secondary endpoints 12 to enable and limit access to the functionality of the first endpoint 10.

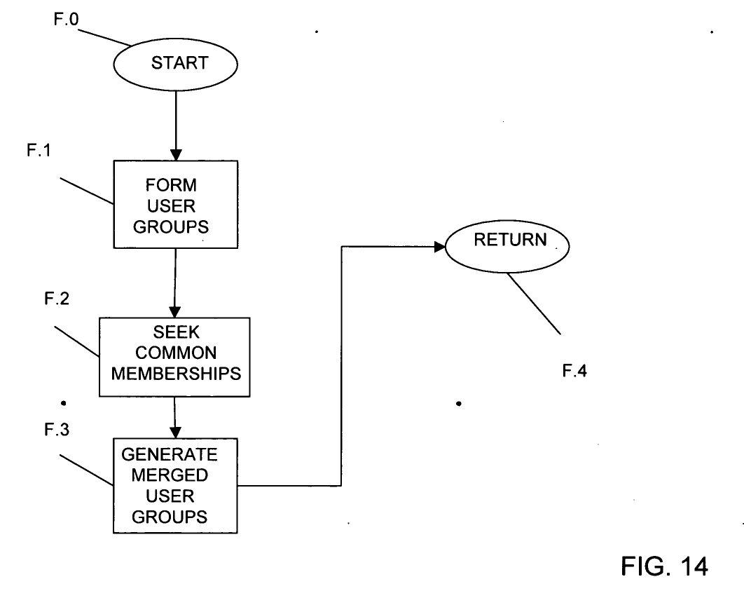

Referring now generally to the Figures and particularly to FIG. 14, a plurality of user groups are formed in step F.1. Where at least one user of a secondary endpoint 12 is a member of at least two user groups is found in step F.2, a second user group is defined and a second set of policies 800.B-812.B are automatically generated and applied to the second user group in step F.3. This second set of policies 800.B-812.B of the second user group includes all permissions extended to the at least one user found in step F.2.

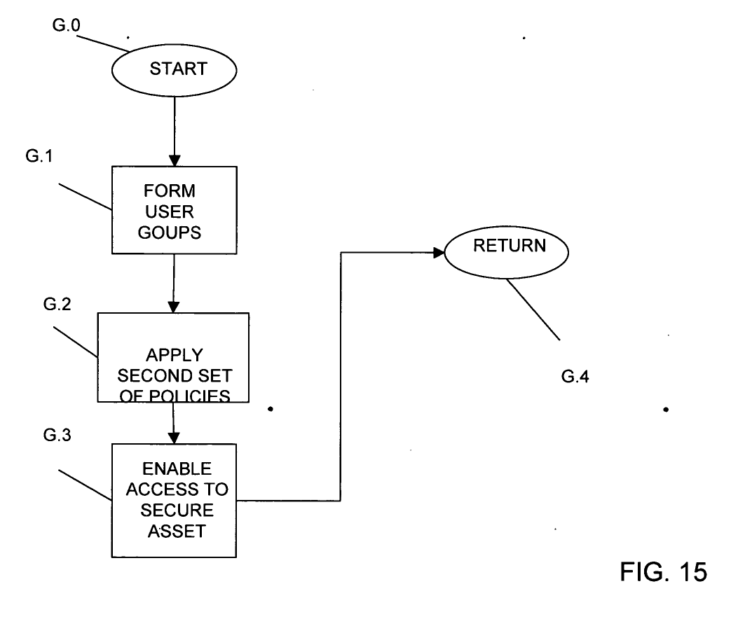

Referring now generally to the Figures and particularly to FIG. 15, a plurality of alternate user groups are formed in step G.1, and a second set of policies 800.B-812.B are applied by the first endpoint 10 in step G.2 to enable and limit access to the functionality by at least one alternate user group. When in step G.3 at least one user of one secondary endpoint 12 of the plurality secondary endpoints 12 is found to be a member of at least two alternate user groups. In step G.4 the user identified in step G.3 may use at least one secondary endpoint to access the functionality of the first endpoint 10 as enabled by any alternate user group to which that user of is a member.

It is understood that the set of policies applied by the first endpoint to enable and limit access to the functionality by the first user group include at least one encryption policy, whereby secure communications rules are automatically applied to the interactivity of the members of the first user group with the functionality. Furthermore, at least one secondary endpoint 12 of the first user group may attempt to access the functionality negotiates IKE keys with the first endpoint 10, in combination with, or in an alternative, by means of suitable encrypted electronic communications techniques known in the art. In particular, access to the functionality may optionally be limited in certain yet additional alternative preferred embodiments of the method of the present invention to encrypted incoming connections.

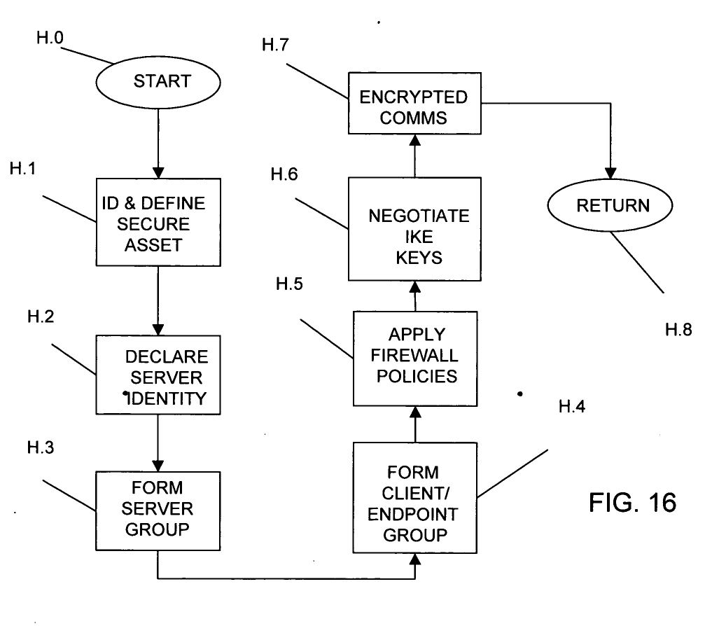

Referring now generally to the Figures and particularly to FIG. 16, a singular or a set of applications or functionalities of an application of a server 52 may be identified as a secure asset 17 in step H.1; and an identity and network address of the server 52 may be declared as the functionality to the central controller computer 50 of the computer network 2 in step H.2. In step H.3 at least one group of servers 52 is defined, and a server 52 identified in H.1 may be declared as a member of the at least one group of servers 52. It is understood that one or more servers 52 may be or comprise an endpoint 8, 10 or 12, a controller computer 50 or a secure access device 6, 14 & 16. In step H.4 at least one client group comprising at least two secondary endpoints 8 is defined and allowed access to the functionality identified in step H.1. The at least one client group of one or more endpoints 8, 10 and/or 12 is allowed access to the functionality of step H.1 in accordance with a set of firewall rules in step H.5 of the policies 800.B-812.B, wherein the set of firewall rules 800.B-812.B allowing and limiting access to the functionality. It is understood that at least client included in the at least one client group of endpoints 8, 10 & 12 may operates, in certain still additional alternative preferred embodiments of the method of the present invention, with individual access rights to the functionality, and the firewall rules of step H.5 are merged in with the access right of the at least one endpoint 8, 10 and/or 12. It is understood that the set of firewall policies applied by the server 52 in step H.5 to enable and limit access to the functionality by the first client group of one or more endpoints 8, 10 and/or 12 include at least encryption policy of the policies 800.B-812.B, whereby secure communications rules are automatically applied to the interactivity of the members of the first client user group with the functionality. In step H.6 an endpoint 8, 10 or 12 member of the first client group may attempt to access the functionality by negotiating IKE keys with the server 52. In step H.7 an endpoint 8, 10 or 12 member of the first client group may access the functionality by means of encrypted electronic communications techniques, wherein the access to the functionality of the secure asset 17 may be limited to encrypted incoming connections.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore, be determined with reference to the knowledge of one skilled in the art and in light of the disclosures presented above.

We claim:

1. A method for providing security to an asset of an information technology network, the method comprising:
a. assigning the asset as a member of a first user group, wherein each member of the first user group interact with the information technology network in accordance with a first user group policy set;
b. merging the first user group policy set with an alternate set of policies of an alternate user group to form a derivative user group policy set; and
d. enabling each member of the alternate user group to interact with the information technology network in accordance with the derivative user group policy set.

2. A method for controlling access to a secure asset of an information technology network, the method comprising:
a. assigning at least one user as a member of a first user group, wherein each member of the first user group is enabled to interact with the information technology network according to a first user group policy set;
b. assigning the secure asset to a second user group, wherein each member of the second user group is enabled to interact with the information technology network according to a second user group policy set;
c. forming a derivative user group, the derivative user group including all members of the second user group, wherein each member of the derivative user group may interact with the information technology network to access the secure asset in accordance with the first user group policy set and the second user group policy set.

3. The method of claim 2, wherein the first user group policy set includes rules controlling communication of information from members of the first user group to the asset.

4. The method of claim 2, wherein the first user group policy set includes rules controlling communication of information from the asset to members of the first user group.

5. The method of claim 2, wherein the second user group policy set includes rules controlling communication of information from known members of the first user group to the asset.

6. The method of claim 2, wherein the second user group policy set includes rules controlling communication of information from the asset to known members of the first user group.

7. The method of claim 2, wherein the derivative user group policy set includes rules controlling communication of information from members of the first user group to the asset.

8. The method of claim 2, wherein the derivative user group policy set includes rules controlling communication of information from the asset to members of the first user group.

9. The method of claim 2, wherein at least one policy of the first user group is selected from the group consisting of an access control policy, a virtual private network policy, an encryption policy, a communications policy, and a bandwidth control policy.

10. The method of claim 2, wherein at least one policy of the second user group is selected from the group consisting of an access control policy, a virtual private network policy, an encryption policy, a communications policy, and a bandwidth control policy.

11. The method of claim 2, wherein at least one policy of the derivative user group is selected from the group consisting of an access control policy, a virtual private network policy, an encryption policy, a communications policy, and a bandwidth control policy.

12. The method of claim 2, further comprising:
a. assigning at least one user as a member of a third user group, wherein each member of the third user group is enabled to interact with the information technology network according to a third user group policy set;
b. forming a second derivative user group, the second derivative user group including all members of the third user group, wherein each member of the derivative user group may interact with the asset in accordance with the first user group policy set and the third user group policy set.

13. The method of claim 12, wherein the second derivative user group policy set includes rules controlling communication of information from members of the third user group to the asset.

14. The method of claim 12, wherein the second derivative user group policy set includes rules controlling communication of information from the asset to members of the third user group.

15. The method of claim 12, wherein at least one policy of the third user group is selected from the group consisting of an access control policy, a virtual private network policy, an encryption policy, a communications policy, and a bandwidth control policy.

16. The method of claim 12, wherein at least one policy of the second derivative user group is selected from the group consisting of an access control policy, a virtual private network policy, an encryption policy, a communications policy, and a bandwidth control policy.

17. A computational system, the system communicatively coupled with an asset of an information technology network, the system comprising:
a. means to assign at least one user as a member of a first user group, wherein each member of the first user group is enabled to interact with the information technology network according to a first user group policy set;
b. means to assign the secure asset to a second user group, wherein each member of the second user group is enabled to interact with the information technology network according to a second user group policy set,
c. means to form a derivative user group, the derivative user group including all members of the second user group, wherein each member of the derivative user group may interact with the information technology network to access the secure asset in accordance with the first user group policy set and the second user group policy set.

18. The system of claim 17, wherein at least one policy of the first user group is selected from the group consisting of an access control policy, a virtual private network policy, an encryption policy, a communications policy, and a bandwidth control policy.

19. The method of claim 17, wherein at least one policy of the second user group is selected from the group consisting of an access control policy, a virtual private network policy, an encryption policy, a communications policy, and a bandwidth control policy.

20. The method of claim 17, wherein at least one policy of the derivative user group is selected from the group consisting of an access control policy, a virtual private network policy, an encryption policy, a communications policy, and a bandwidth control policy.

21. A method for managing the security provided to a secure asset by permitting a query of the access allowed by any individual user based on membership in a user group policy set.
